(19) United States
(12) Patent Application Publication
(10) Pub. No.: US 2006/0289638 A1
(43) Pub. Date: Dec. 28, 2006

(54) Voting verification system and method

(76) Inventor: Donald L. Schilling, Palm Beach Gardens, FL (US)

Correspondence Address: DAVID NEWMAN CHARTERED, P.O. BOX 956, Indian Head, MD, 20640, US

(21) Appl. No.: 11/167,905

(22) Filed: Jun. 27, 2005

(51) Int. Cl. G07C 13/00

(52) U.S. Cl. 235/386

(57) ABSTRACT

A database server stores identification data, voter registration data, and voting-status data, of each multiplicity of voters located in each remote-voting area, respectively, of a plurality of remote-voting areas. A plurality of remote workstations are located at a plurality of remote-voting areas, respectively. Each remote-voting area may be located in different geographic area from other remote-voting areas in the plurality of remote-voting areas. Each remote workstation in a respective remote-voting area, is coupled through a network to the database server. Voter-identification data are sent on each voter to the database server. The database means is accessed for verifying eligibility of the voter for voting from the identification data, registration of the voter from the registration data, and voting status of the voter from the voting-status data.

### BACKGROUND OF THE INVENTION

This patent is about a voter verification system and method, and more particularly, a system and method using a national database of voter identification data from which a voter is verified in a remoter area.

### DESCRIPTION OF THE RELEVANT ART

Current voting registration and voting systems are decentralized. Typically, a voter registers and votes at a local precinct, without verification of concurrent registration or status of the voter.

### SUMMARY OF THE INVENTION

A general object of the invention is to centralize voter registration verification and voting verification.

According to the present invention, as embodied and broadly described herein, a voting verification system and method are provided. A database server stores identification data, voter registration data, and voting-status data, of each of a multiplicity of voters located in each remote-voting area, respectively, of a plurality of remote-voting areas. A plurality of remote workstations are located at a plurality of remote-voting areas, respectively. Each remote-voting area is located in different geographic area from other remote-voting areas in the plurality of remote-voting areas. Each remote workstation in a respective remote-voting area, is coupled through a network to the database server. Voter-identification data are sent on each voter to the database server. The database means is accessed for verifying eligibility of the voter for voting from the identification data, registration of the voter from the registration data, and voting status of the voter from the voting-status data.

The voting verification system may additionally store, in the database server, one or more of death-record data, felony record data, driver-license data, DNA data, eye-scan data, fingerprint data, of each of the multiplicity of voters located in each remote-voting area of the plurality of remote-voting areas. The voting verification system may have each remote workstation of the plurality of remote workstations additionally obtain, from each voter of the multiplicity of voters located in each remote-voting area, the one or more of death-record data, felony record data, driver-license data, DNA data, eye-scan data, fingerprint data. The one or more of death-record data, felony record data, driver-license data, DNA data, eye-scan data, fingerprint data are sent to the database server, for verifying eligibility of the voter for voting from the one or more of death-record data, felony record data, driver-license data, DNA data, eye-scan data.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 is a block diagram of the voting verification system; and

FIG. 2 illustrates a plurality of database servers.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

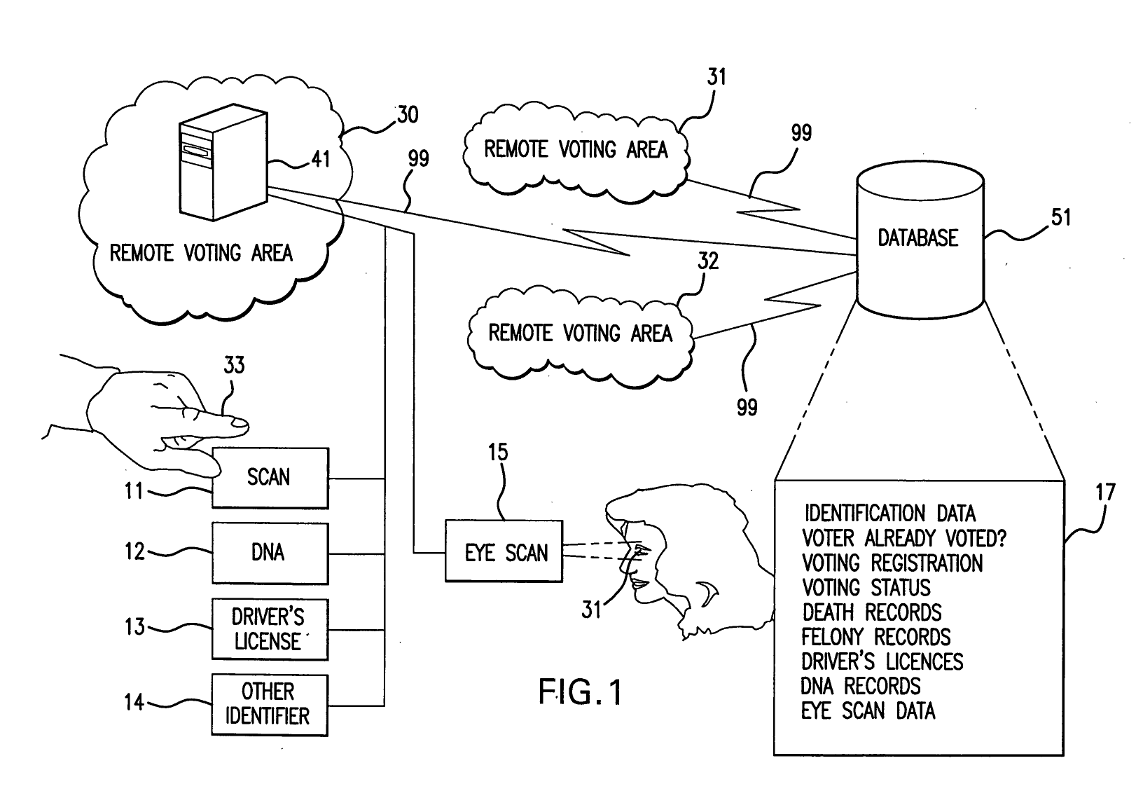

In the exemplary arrangement shown in FIG. 1, a voting verification system is shown having database means, and a plurality of remote workstations 41. The database means and the plurality of remote workstations 41 are connected through a network 99. Typically the network is a wide area network (WAN), covering a large geographical area. The invention anticipates the wide area network will cover the United Stated of America. The invention also could cover Europe, Asia, and elsewhere, where transients and soldiers are located. The Internet, or a satellite net, may be used as the wide area network.

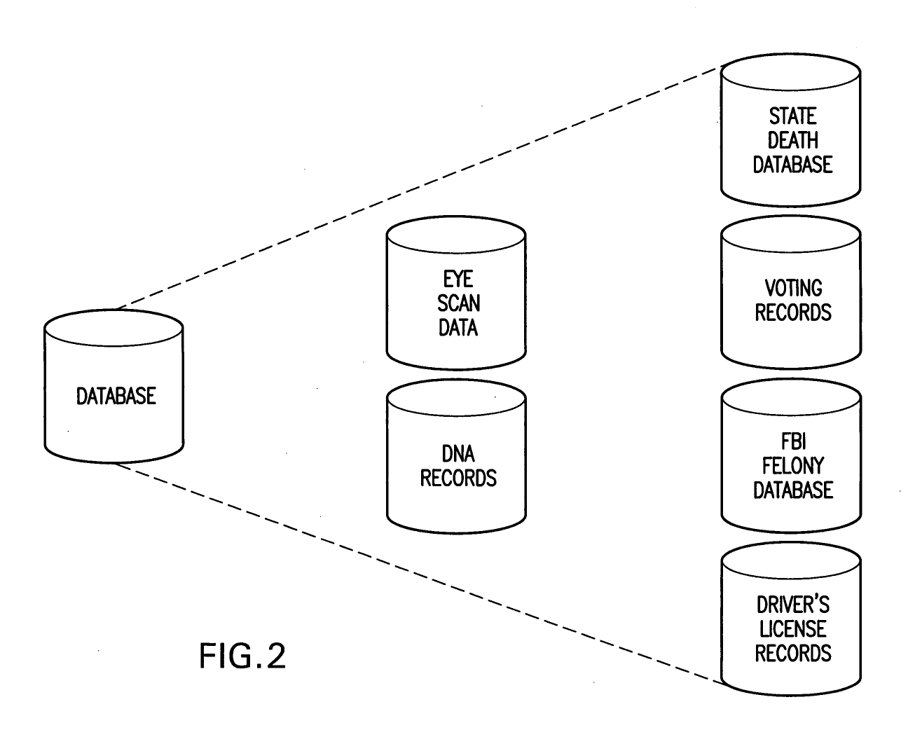

The database means typically is embodied as a database server having a database 51. The database means alternatively may include, as shown in FIG. 2, a plurality of database servers, or a database server having access to other database servers.

The database means stores identification data, voter registration data, local address which is needed for municipal elections, and voting-status data, of each of the multiplicity of voters located in each remote-voting area, respectively, of a plurality of remote-voting areas.

The plurality of remote workstations is located in the plurality of remote-voting areas 30, 31, 32, respectively. Each remote-voting area is located in different geographic area from other remote-voting areas in the plurality of remote-voting areas, each remote workstation 41 in a respective remote-voting area 30. Each remote-voting area could be co-located or overlap other remote-voting areas in the plurality of remote-voting areas. The plurality of remote workstations should be available to all voters, no matter where they are located.

The plurality of remote workstations is coupled through a network 99 to the database means. The plurality of remote workstations sends voter-identification data on each voter to the database means, and accesses the database means for verifying eligibility of the voter for voting from the identification data, registration of the voter from the registration data, and voting status of the voter, such as whether has already voted, entitled to vote, from the voting-status data 17.

The voting verification system additionally may have the database means store other data such as death-record data, felony record data, driver-license data, DNA data, eye-scan data 17, fingerprints, or other techniques used to identify and determine eligibility, of each of the multiplicity of voters located in each remote-voting area of the plurality of remote-voting areas.

The voting verification system may have each remote workstation 41 of the plurality of remote workstations additionally obtain, from each voter of the multiplicity of voters located in each remote-voting area, fingerprint scan 11 of a finger 33, driver-license data 13, DNA data 12, eye-scan data 15 of an eye 31, or other data 14, for sending to the database means. The database means then verifies eligibility of the voter from the driver-license data 13, DNA data 12, eye-scan data 15, or other identification data 14.

Prior to voting, each eligible voter (Registrant), goes to an available Registration Office. The Registrar verifies the legal eligibility, as determined by statute, such as US Citizenship, checks the Registrants legal voting address, and enters the appropriate legal Voting Precinct on the Registration Card. The Registrant presses his appropriate finger 33 on the Fingerprint Machine 11 and the fingerprint, or eye scan, or DNA sample, is taken. The fingerprint and Legal Voting Precinct of the Registrant is transmitted to, and stored in, the database means, which may be embodied as a national database. Note that by using this procedure it is not necessary to partition the database by state, or by any additional subset, such as county, city, etc. The database means transmits back to the Registrar that the Registrant has been registered or the nature of the problem found after searching the available records.

The database means can check to see if the individual is a citizen, a wanted criminal, or a released felon, who may therefore possibly be excludable from voting. The database means can check prior voting records, tax records to determine residence, or other indications of residence. This may be required for municipal, state, or regional elections.

The Registrant's name is not required for the voting phase. The Registrant could be known only by his fingerprint, or other identifying factor, thereby providing privacy.

No Registration Card need be issued to the Registrant. The fingerprint, or other identifying factor, is the Registration Card.

A Registrant can register anywhere in the world at which Registration Machines are located.

The Registrant can only register once, since the fingerprint, or other identifying factor, is the key (initial) element in the Data-Base to be checked, not the Voting Precinct.

In lieu of a fingerprint, an eye print, a handwriting, such as a signature, DNA sample, or any other computer identifiable procedure could be used.

The fingerprint data is packetized prior to sending. That is, a Message is to be sent. The Message contains a header for synchronization, the Voter's Fingerprint, the Voter's legal voting area which can be determined by income tax return, social security number, water bill, phone bill, etc., and may also contain the Voter's address, as well as the location, which marks the city, County, Town, State, Village, etc., from which the vote is being cast. This procedure need be performed only once for national elections, but may be required if local elections.

Voting

At election time, the Voter enters a voting room and presses his/her finger on the Fingerprint Machine. The Machine transmits the fingerprint to the Data-Base, which checks to see if the individual is a registered voter.

The Data-Base responds with two or more pieces of information: (1) if the Voter is a registered voter, and (2) when the voter last applied to vote, information that eliminates multiple voting in a single election. The time for this transaction to occur is typically less than 10 seconds.

If the Voter is registered, and has not already voted, and is eligible to vote, the voter is sent to the voting machine to vote.

The database will notify the Election Official whether or not the Voter has already previously voted. This prevents double voting.

The fingerprint data is packetized prior to sending. That is, a message is to be sent. The message contains a header for synchronization, and the voter's fingerprint. The message may also contain the voter's address, as well as the location, which marks the city, County, Town, State, Village, etc., from which the vote is being cast.

The voter can vote at any voting precinct, which is connected to the database, since the database contains all of the required eligibility information.

The present invention also includes a voting verification method. The method comprises the steps of storing, in a database server 51, identification data, voter registration data, and voting-status data 17, of each multiplicity of voters located in each remote-voting area, respectively, of a plurality of remote-voting areas. The method further sends, from a plurality of remote workstations 41 located at a plurality of remote-voting areas, respectively, each remote-voting area located in different geographic area from other remote-voting areas in the plurality of remote-voting areas 30, 31, 32, each remote workstation in a respective remote-voting area, coupled through a network 99 to the database server 51, voter-identification data on each voter to the database server, for accessing the database server 51 for verifying eligibility of the voter for voting from the identification data, registration of the voter from the registration data, and voting status of the voter from the voting-status data.

The voting verification method may further include the step of storing in the database means, identification data, whether voter has voted, voting registration, voting status, death records, felony records, drivers license, DNA records, eye scan data or other data 17, of each of the multiplicity of voters located in each remote-voting area of the plurality of remote-voting areas.

The voting verification method may further include the step of obtaining, with each remote workstation of the plurality of remote workstations, from each voter of the multiplicity of voters located in each remote-voting area, the one or more of death-record data, felony record data, driver-license data, DNA data, eye-scan data for sending to the database means. Eligibility of the voter for voting is verified from the death-record data, felony record data, driver-license data, DNA data, eye-scan data.

It will be apparent to those skilled in the art that various modifications can be made to the voting verification system and method of the instant invention without departing from the scope or spirit of the invention, and it is intended that the present invention cover modifications and variations of the voting verification system and method provided they come within the scope of the appended claims and their equivalents.

I claim:

1. A voting verification system comprising:
database means for storing identification data, voter registration data, and voting-status data, of each multiplicity of voters located in each remote-voting area, respectively, of a plurality of remote-voting areas; and
a plurality of remote workstations located at a plurality of remote-voting areas, respectively, each remote workstation in a respective remote-voting area, coupled through a network to said database means, for sending voter-identification data on each voter to said database means, for accessing said database means for verifying eligibility of the voter for voting from the identification data, registration of the voter from the registration data, and voting status of the voter from the voting-status data.

2. The voting verification system as set forth in claim 1, with said database means additionally for storing at least two of death-record data, felony record data, driver-license data, DNA data, eye-scan data, of each of the multiplicity of voters located in each remote-voting area of the plurality of remote-voting areas.

3. The voting verification system as set forth in claim 2, with each remote workstation of the plurality of remote workstations additionally for obtaining, from each voter of the multiplicity of voters located in each remote-voting area, the at least two of death-record data, felony record data, driver-license data, DNA data, eye-scan data, for sending to said database means, for verifying eligibility of the voter for voting from the at least two of death-record data, felony record data, driver-license data, DNA data, eye-scan data.

4. A voting verification system comprising:
a database server for storing identification data, voter registration data, and voting-status data, of each multiplicity of voters located in each remote-voting area, respectively, of a plurality of remote-voting areas; and
a plurality of remote workstations located at a plurality of remote-voting areas, respectively, each remote workstation in a respective remote-voting area, coupled through a network to said database server, for sending voter-identification data on each voter to said database server, for accessing said database means for verifying eligibility of the voter for voting from the identification data, registration of the voter from the registration data, and voting status of the voter from the voting-status data.

5. The voting verification system as set forth in claim 4, with sad database additionally for storing at least two of death-record data, felony record data, driver-license data, DNA data, eye-scan data, of each of the multiplicity of voters located in each remote-voting area of the plurality of remote-voting areas.

6. The voting verification system as set forth in claim 5, with each remote workstation of the plurality of remote workstations additionally for obtaining, from each voter of the multiplicity of voters located in each remote-voting area, the at least two of death-record data, felony record data, driver-license data, DNA data, eye-scan data, for sending to said database server, for verifying eligibility of the voter for voting from the at least two of death-record data, felony record data, driver-license data, DNA data, eye-scan data.

7. A voting verification method comprising the steps of:
storing, in a database server, identification data, voter registration data, and voting-status data, of each multiplicity of voters located in each remote-voting area, respectively, of a plurality of remote-voting areas; and
sending, from a plurality of remote workstations located at a plurality of remote-voting areas, respectively, each remote-voting area located in different geographic area from other remote-voting areas in the plurality of remote-voting areas, each remote workstation in a respective remote-voting area, coupled through a network to said database server, voter-identification data on each voter to said database server, for accessing said database server for verifying eligibility of the voter for voting from the identification data, registration of the voter from the registration data, and voting status of the voter from the voting-status data.

8. The voting verification method as set forth in claim 7, with the storing step further including the step of storing at least two of death-record data, felony record data, driver-license data, DNA data, eye-scan data, of each of the multiplicity of voters located in each remote-voting area of the plurality of remote-voting areas.

9. The voting verification method as set forth in claim 8, further including the step of obtaining, with each remote workstation of the plurality of remote workstations, from each voter of the multiplicity of voters located in each remote-voting area, the at least two of death-record data, felony record data, driver-license data, DNA data, eye-scan data for sending to said database means; and
verifying eligibility of the voter for voting from the at least two of death-record data, felony record data, driver-license data, DNA data, eye-scan data.
